(19) United States
(12) Patent Application Publication
(10) Pub. No.: US 2018/0183746 A1
(43) Pub. Date: Jun. 28, 2018

(54) E-MAIL MANAGING APPARATUS SUITABLE FOR CHECKING CONTENTS OF E-MAIL EXCHANGE, AND RECORDING MEDIUM

(71) Applicant: KYOCERA Document Solutions Inc., Osaka (JP)

(72) Inventor: Ryota ARINOBU, Osaka (JP)

(73) Assignee: KYOCERA Document Solutions Inc., Osaka (JP)

(21) Appl. No.: 15/854,475

(22) Filed: Dec. 26, 2017

(30) Foreign Application Priority Data
Dec. 26, 2016 (JP) 2016-250969

(51) Int. Cl. H04L 12/58; G06F 17/30

(52) U.S. Cl. CPC H04L 51/22; G06F 17/30705; G06F 17/30716

(57) ABSTRACT

Provided is an e-mail managing apparatus that easily performs a check of the contents of a mail exchange for a specified mail. An HDD (storage device) of an e-mail-managing server stores sent mail and received mail from a user terminal and that includes tags for specifying categories of contents of messages, a mail-managing unit, based on the tags, creates a mail-correlation diagram that indicates contents of mail exchange for a specified mail, and a system-control unit sends the mail-correlation diagram that is created by the mail-managing unit to the user terminal. As a result, by using the mail-correlation diagram it is possible to express the correlation of the contents of the mail exchange.

### INCORPORATION BY REFERENCE

This application is based on and claims the benefit of priority from Japanese Patent Application No. 2016-250969 filed on Dec. 26, 2016, the contents of which are hereby incorporated by reference.

### BACKGROUND

The present disclosure relates to an e-mail managing apparatus that is suitable for checking the contents of e-mail exchange, and to a recording medium.

A mailer that creates, sends and receives e-mail (hereafter, referred to as mail) is provided with an outbox for sent mail, for example and an inbox for received mail. Moreover, in a mailer, a function is also mounted for performing a batch display in thread units of past exchanges for mail in the outbox and in the inbox.

Incidentally, in the batch display in thread units, it is possible to rearrange mail, for example, in order of sent date, or in order of communication party, however, in order to check the contents of the respective mail, it is necessary to click on the thread heading and display a browsing window. In this case, in order to arrive at the target mail, it is necessary to check the contents of each respective mail in the browsing window, which takes time.

In order to eliminate this kind of inconvenience, in typical technology, when the mailer sends or receives mail, message-analysis-accumulation logic analyzes the mail and links phrases in parent mail that are cited by the mail with a description that cites the mail, and stores the result in a database. When any one mail item is selected from the outbox mailbox or the inbox mailbox, display-sentence-search logic searches for and acquires a description that cites a phrase in mail having a parent-child relationship with the selected mail from the database for each phrase of the description in the selected mail. Then, for each phrase of the selected mail, there is an e-mail display apparatus that displays the phrase searched in a hierarchical structure in association with cited descriptions.

### SUMMARY

The e-mail managing apparatus according to the present disclosure includes a storage device, a mail-managing unit and a system-control unit. The storage device stores sent mail and received mail including tags for identifying the categories of the contents of messages from a user terminal. The mail-managing unit, based on the tags, creates a mail-correlation table that indicates the contents of a mail exchange for a specified mail. The system-control unit sends the mail-correlation table that is created by the mail-managing unit to the user terminal.

The non-transitory computer readable recording medium according to the present disclosure stores an e-mail-managing program that can be executed by the computer of the e-mail managing apparatus. The e-mail-managing program causes the computer to store sent mail and received mail including tags for identifying the categories of the contents of messages from a user terminal. Moreover, the e-mail-managing program causes the computer to operate as a mail-managing unit that, based on the tags, creates a mail-correlation table that indicates the contents of a mail exchange for a specified mail, and a system-control unit that sends the mail-correlation table that is created by the mail-managing unit to the user terminal.

### BRIEF DESCRIPTION OF THE DRAWINGS

FIG. 1 is a drawing for explaining an embodiment of an e-mail managing apparatus according to the present disclosure.

FIG. 2 illustrates the configuration of the user terminal and e-mail-managing server in FIG. 1.

FIG. 3A explains the contents that are displayed by the display unit of the user terminal in FIG. 2, and illustrates, for example, an outline of the mail format used when creating a sent mail.

FIG. 3B explains the contents that are displayed by the display unit of the user terminal in FIG. 2, and illustrates a list of mail received from the e-mail-managing server in FIG. 2.

FIG. 4 illustrates a mail-management table that is managed by the mail-managing unit of the e-mail-managing server in FIG. 2.

FIG. 5 illustrates a mail-correlation diagram that is created by the mail-managing unit of the e-mail-managing server in FIG. 2.

FIG. 6 illustrates steps of processing on the user terminal side in FIG. 1.

FIG. 7 illustrates steps of processing on the e-mail-managing server side in FIG. 1.

### DETAILED DESCRIPTION

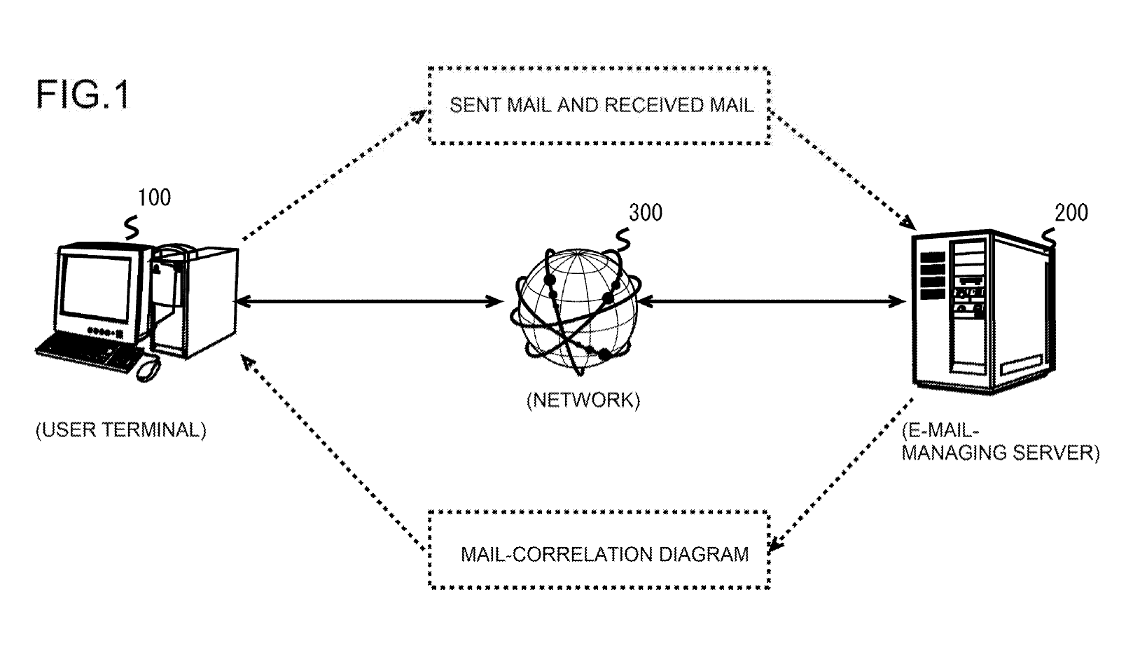

In the following, an embodiment of an e-mail managing apparatus according to the present disclosure will be explained with reference to FIG. 1 to FIG. 7. The e-mail managing apparatus in the following explanation is an e-mail-managing server that manages sent mail and received mail that are stored in each user terminal.

First, as illustrated in FIG. 1, an e-mail-managing server 200 is connected to a user terminal 100 via a network 300. The user terminal 100 is not limited to being a PC (Personal Computer), and may be another apparatus such as portable telephone like a smartphone and the like, a tablet terminal and the like.

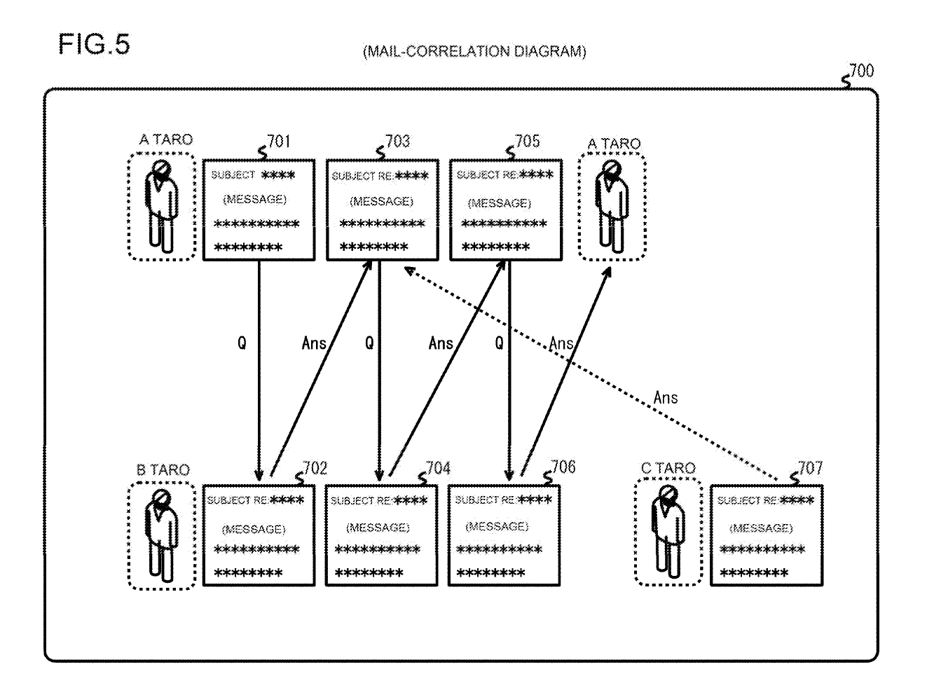

Here, the user terminal 100 creates, sends and receives e-mail (hereafter, referred to as mail) using a mailer. The mailer is provided, for example, with an outbox for sent mail, and an inbox for received mail. Moreover, as will be described in more detail later, the user terminal 100 transfers sent mail and received mail that are stored in the outbox or the inbox to the e-mail-managing server 200. Furthermore, from the e-mail-managing server 200, the user terminal 100 receives, for example, a mail-correlation diagram 700 as illustrated in FIG. 5 described later that gives a timeline of exchanged contents of the mail 701 to 707 illustrated in FIG. 5 described later.

The e-mail-managing server 200, as will be described in detail later, manages the sent mail and received mail that are received from the user terminal 100, and based on an instruction from the user terminal 100, creates and sends the mail-correlation diagram 700 illustrated in FIG. 5.

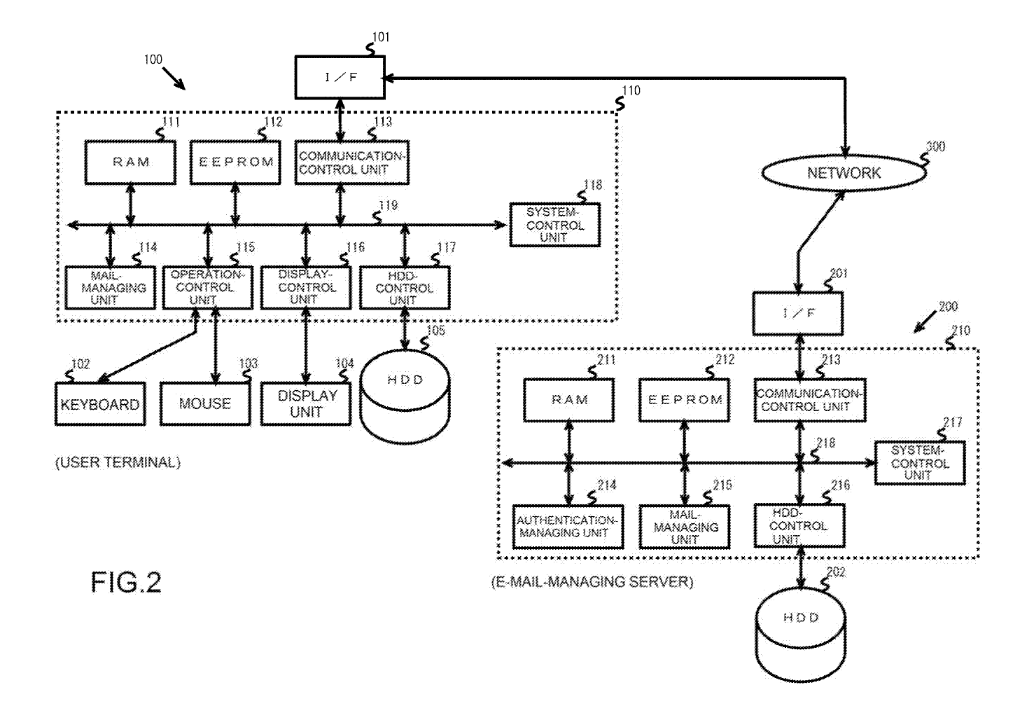

Next, the configuration of the user terminal 100 and the e-mail-managing server 200 will be explained with reference to FIG. 2.

The user terminal 100 includes a control unit 110 that controls the operation of an I/F (interface) 101, a keyboard 102, a mouse 103, a display unit 104, and a HDD 105. The I/F 101 is connected to an e-mail-managing server 200, a SMTP (Simple Mail Transfer Protocol) sever that is managed by a communications business and the, and the like via a network 300. The I/F 101 may take charge of communication with other user terminals and the like. Moreover, the I/F 101 may take charge of communication with a content server, web server and the like. The keyboard 102 is used by operating keys that are arranged on the board surface, and is used for inputting information such a characters and the like. The mouse 103 is used for inputting information such as a target input position on the surface of the display unit 104. The display unit 104 displays information such as sent mail, received mail and the like. The HDD 106 is a storage device that stores application programs and the like for providing various functions of the user terminal 100.

The control unit 110 is a processor that controls the overall operation of the user terminal 100 by executing a control program. The control unit 110 includes a RAM (Random Access Memory) 111, an EEPROM (Electrically Erasable Programmable Read-Only Memory) 112, a communication-control unit 113, a mail-managing unit 114, an operation-control unit 115, a display-control unit 116, a HDD-control unit 117, and a system-control unit 118. Moreover, these are connected to a data bus 119.

The RAM 111 is a work memory for executing programs. The EEPROM 112 stores a control program for performing operation checks and the like of each of the respective units. Moreover, the EEPROM 112 stores firmware for operating the I/F 101, the keyboard 102, the mouse 103, the display unit 104 and the HDD 105.

The communication-control unit 113, via the I/F 101, performs control of sending and receiving data and the like over the network 300. The mail-managing unit 114, by executing a mailer, manages sent mail and received mail that are stored in the transmission box and the reception box. Moreover, the mail-managing unit 114 manages account information and the like that identifies a user in order to log into the e-mail-managing server 200. The operation-control unit 115 receives input of information from the keyboard 102 and the mouse 103. The display-control unit 116 controls the display operation of the display unit 104. The HDD-control unit 117 controls writing and reading information to and from the HDD 105.

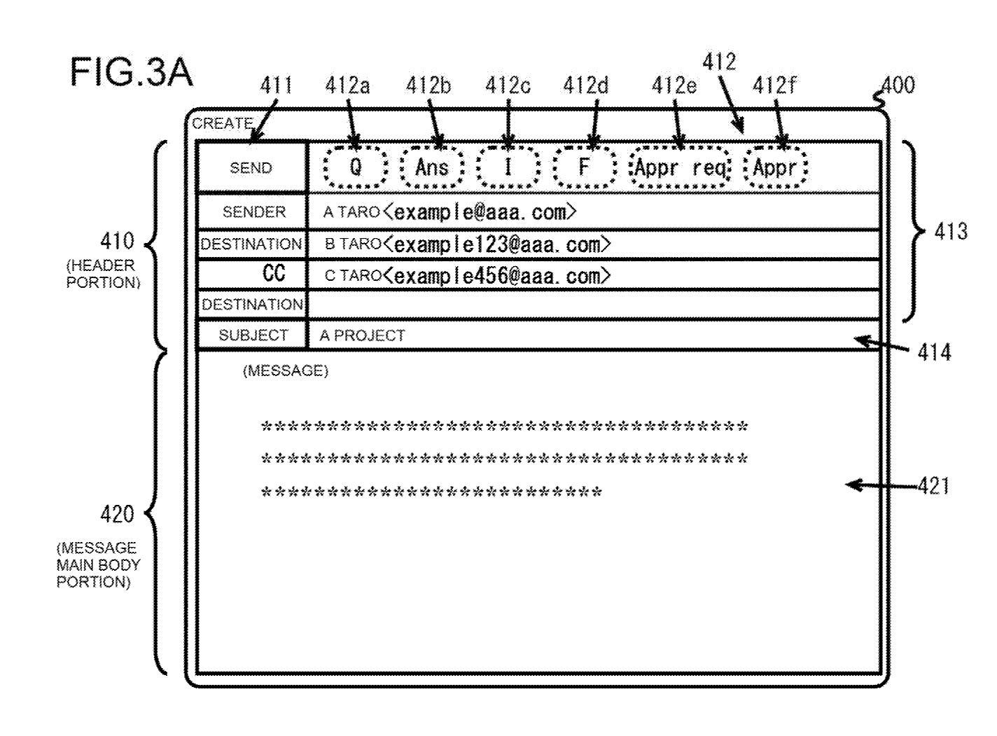

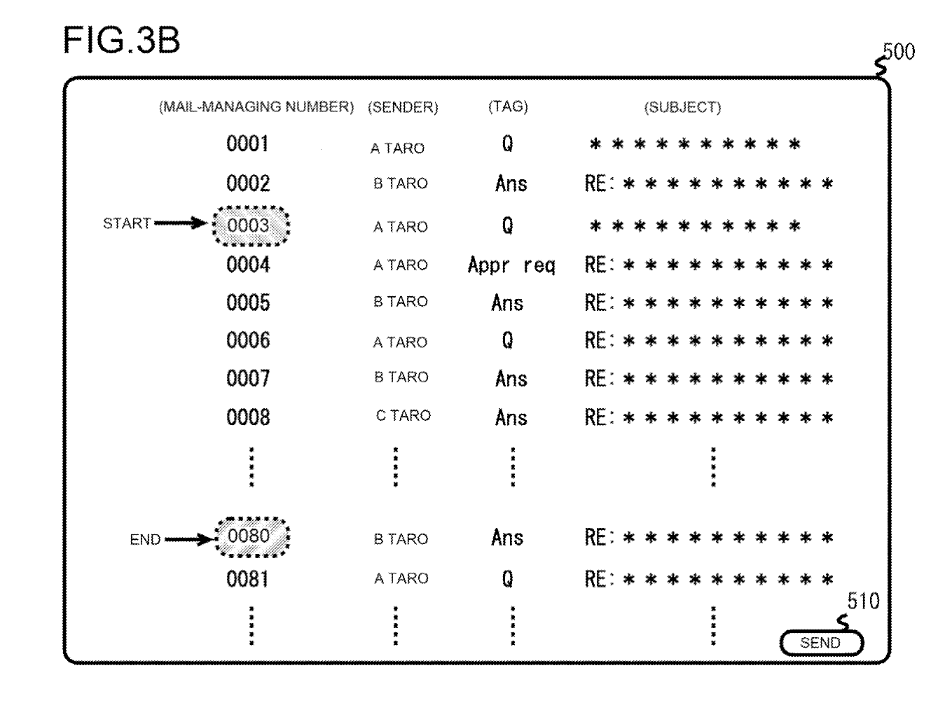

The system-control unit 118 transfers sent mail and received mail that is managed by the mail-managing unit 114 to the e-mail-managing server 200 via the communication-control unit 113. Transferring sent mail and received mail to the e-mail-managing server 200 may be automatic, or may be manual. In the case of transferring mail automatically, a period such as daily, weekly, monthly and the like are set via the display unit 104. Moreover, in the case of transferring mail manually, an instruction for transferring mail is given on a transfer screen that is displayed by the display unit 104. Furthermore, when there is an acquisition request for acquiring a mail list 500 as illustrated in FIG. 3B described later on a mail-list-request screen that is displayed by the display unit 104, the system-control unit 118, via the communication-control unit 113, outputs a send request for a mail list 500 to the e-mail-managing server 200. Moreover, as illustrated in FIG. 3B described later, specified mail (for example, mail 701 in FIG. 5 described later), and the last mail of a mail exchange (for example, mail 706 in FIG. 5 described later) are set in the mail list 500. Then, the system-control unit 118 sends that set mail list 500 to the e-mail-managing server 200. After that, a mail-correlation diagram 700 as illustrated in FIG. 5 described later is received from the e-mail-managing server 200. This will be described in detail later.

The e-mail-managing server 200 includes a control unit 210 that controls the operation of the I/F 201 and the HDD 202. The I/F 201 is connected to the user terminal 100 via a network 300. The I/F 201 may take charge of communication with other user terminals and the like. The HDD 202 is a storage device that stores application programs for providing various functions of the e-mail-managing server 200, and sent mail and received mail that is transferred from the user terminal 100, and the like.

The control unit 210 is a processor that controls the overall operation of the e-mail-managing server 200 by executing a control program and the like. The control unit 210 includes a RAM 211, and EEPROM 212, a communication-control unit 213, an authentication-managing unit 214, a mail-managing unit 215, a HDD-control unit 216, and a system-control unit 217. Moreover, these are connected to a data bus 218.

The RAM is a work memory for executing programs. The EEPROM 212 stores a control program for performing operation checks and the like of each of the respective units. Moreover, the EEPROM 212 stores firmware for operating the HDD 202 and the like.

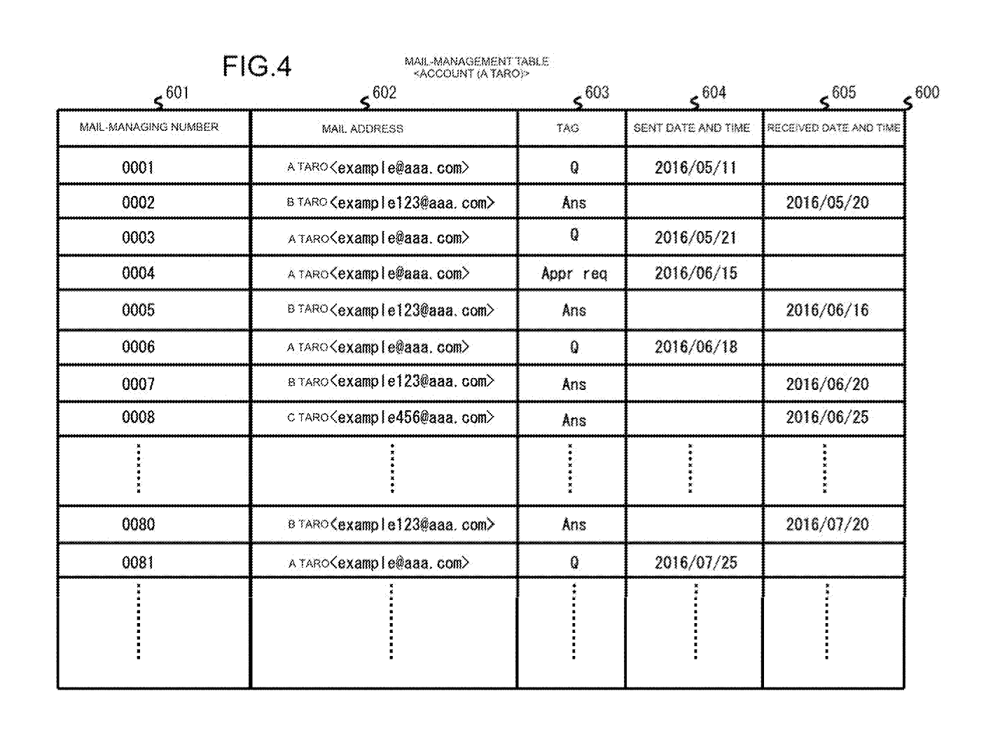

The communication-control unit 213, via the I/F 201, performs control of sending and receiving data and the like over the network 300. The authentication-managing unit 214 manages account information for identifying a user that is included in a login request from the user terminal 100, and performs user authentication. The mail-managing unit 215 manages sent mail and received mail that are transferred from the user terminal 100 according to a mail-management table 600 as illustrated in FIG. 4 described later. Moreover, the mail-managing unit 215, based on an instruction from the user terminal 100, creates a mail list 500 as illustrated in FIG. 3B described later. The HDD-control unit 216 controls writing and reading information to and from the HDD 202.

When there is a login request from the user terminal 100, the system-control unit 217 instructs the authentication-managing unit 214 to perform user authentication. Moreover, the system-control unit 217, via the HDD-control unit 216 stores sent mail and received mail that are transferred from the user terminal 100 in the HDD 202. The system-control unit 217 instructs the mail-managing unit 215 to manage the sent mail and received mail that are stored in the HDD 202. Furthermore, when there is a send request to send the mail list 500 illustrated in FIG. 3B described later from the user terminal 100, the system-control unit 217 instructs the mail-managing unit 215 to create a mail list 500. Moreover, the case will be explained of receiving a reply from the user terminal 100 of a mail list 500 in which specified mail (for example, mail 701 in FIG. 5 described later), and the last mail of a mail exchange (for example, mail 706 in FIG. 5 described later) are set. In this case, the system-control unit 217 instructs the mail-managing unit 215 to create a mail-correlation diagram 700 as illustrated in FIG. 5 described later.

Next, the contents that are displayed on the display unit 104 of the user terminal 100 will be explained with reference to FIG. 3A and FIG. 3B. First, FIG. 3A illustrates an outline of the mail format 400 when creating mail to send for example. The mail format 400 is configured with a heater portion 410 and a message main body portion 420. A send-selection field 411 for giving an instruction to send created mail, a tag-display field 412, an address-input field 413, and a subject-input field 414 are provided in the header portion 410. Moreover, time information that indicates the sent date and time (corresponds to sent date and time 604 in FIG. 4) and received date and time (corresponds to received date and time 605 in FIG. 4) is also included in the header portion 410. A message input field 421 is provided in the message main body portion 420.

Here, in a tag-display field 412, the tag-selection fields 412a to 412f for tags that indicate, for example, Q (question), Ans (answer), I (shared information), F (free), Appr req (approval request), Appr (approval) are provided. These tag-selection fields 412a to 412f are for specifying the category of the contents of the message that is inputted into the message-input field 421. Moreover, the tag Q (question) and the tag Ans (answer) indicate correspondence. Moreover, the tag Appr req (approval request) and the tag Appr (approval) indicate correspondence. The tags that are illustrated here are just an example, and the contents and number of tags can be arbitrarily set. Furthermore, tags are not limited to text characters, and the tags may be marks, character characters and the like. Moreover, the arrangement location of the tag-display field 412 is not limited to being next to the send-selection field 411, and may be an arranged at an arbitrary location of the header portion 410.

In addition, when the contents of a message that is inputted into the message-input field 421 is a question, for example, tag-selection field 412a that indicates Q (question) is selected in the in the tag-display field 412. Then, when the send-selection field 411 is selected, the system-control unit 118, via the communication-control unit 113, sends mail to which the tag Q (question) is attached (for example, mail 701 in FIG. 5 described later).

Next, FIG. 3B illustrates a mail list 500 that is received from the e-mail-managing server 200. The mail list 500 illustrates a list of sent mail and received mail from the user terminal 100 that is stored in the HDD 202 on the e-mail-managing server 200 side. In the mail list 500, the sender, tag, subject and the like that are linked with the mail-management number (mail-management number 601 in FIG. 4 described later) for managing the sent mail and the received mail managed by the mail-managing unit 215 on the e-mail-managing server 200 side are displayed in ascending order of the mail-management number.

Here, when checking the contents of a mail exchange (for example, mail 701 to 707 in FIG. 5 described later) by using the mouse 103, for example, the mail-management number (0003) that corresponds to specified mail (for example, mail 701 in FIG. 5 described later) and the mail-management number (0080) that corresponds to the last mail (for example, mail 706 in FIG. 5 described later) of a mail exchange (for example, mail 701 to 707 in FIG. 5 described later) are selected. FIG. 3B illustrates that the selection of the mail-management number (0003) that corresponds to specified mail is taken to be the start, and the mail of the last mail-management number (0080) of the mail exchange is taken to be the end. Here, the mail-management number that corresponds to mail having a sent date and time or received date and time that is later than the specified mail, or in other words, the mail-management number that is larger than the mail-management number the correspond to specified mail, can be selected as the mail-management number that corresponds to the last mail. Moreover, by selecting the send button 510 after the start and end are selected in the mail list 500, the system-control unit 118, via the communication-control unit 113, returns the mail list 500 to the e-mail-managing server 200. Selection of the end of the mail list 500 may be omitted.

In this embodiment, the mail-management numbers in the mail list 500 are given in ascending order of sent date and time and received date and time, however, may also be given in descending order of sent date and time and received date and time. In this case, mail-management numbers that correspond to mail having a sent date and time or received date and time later than the specified mail, or in other words, mail-management numbers that are smaller than the mail-management number that corresponds to the specified mail can be selected as the mail-management number that corresponds to the last mail.

Next, the mail-management table 600 that is managed by the mail-managing unit 215 of the e-mail-managing server 200 will be explained with reference to FIG. 4. A mail-management table 600 is provided for each user that has registered account information. The account information includes an account (user name) and a password. Here, the mail-management table 600 in FIG. 4 illustrates the case when the account is A Taro.

The mail-management table 600 is for linking sent mail and received mail that are transferred from the user terminal 100 with mail-management numbers 601 and managing the mail, a mail address 602, a tag 603, a sent date and time 604, and a received date and time 605 and the like are registered. The mail address 602, tag 603, sent date and time 604, and received date and time 605 and the like are acquired from the header portion 410 in FIG. 3A of sent mail and received mail that are transferred from the user terminal 100.

Next, the mail-correlation diagram 700 that is created by the mail-managing unit 215 will be explained with reference to FIG. 5. FIG. 5 illustrates a mail-correlation diagram 700 that is created based on the start and end that is selected on the mail list 500 in FIG. 3B.

In the mail-correlation diagram 700, the mail-management number (0003) that is selected in the mail list 500 in FIG. 3B is taken to be the specified mail 701, and the mail-management number (0080) is taken to be the last mail 706 of the mail exchange, and this mail-correlation diagram 700 illustrates a timeline of the respective mail 701 to 707. In other words, when the specified mail is mail 701 that is sent by A Taro and to which a tag Q (question) is attached, the contents of the exchange with regard to that mail 701 is expressed in a timeline. In this case, the mail-managing unit 215 searches the mail-management numbers 601 between mail 701 that corresponds to the mail-management number (0003) and mail 706 that corresponds to the mail-management number (0080) that are selected in the mail list 500, to which the tag Q (question) or the tag Ans (answer) is attached.

Moreover, the mail-managing unit 215 searches the mail-management numbers 601 to which the tag Q (question) or tag Ans (answer) is attached. Then, the mail-managing unit 215 reads the corresponding sent mail and received mail from the HDD 202, and creates a mail-correlation diagram 700 that illustrates the contents of the exchange of the respective mail 701 to 707 in a timeline. In other words, the mail-correlation diagram 700 illustrates the following. There is Ans (answer) mail 702 from B Taro in response to Q (question) mail 701 that is a sent by A Taro. Moreover, when A Taro sends Q (question) mail 703 in response to the Ans (answer) mail 702 from B Taro, there is Ans (answer) mail 704 from B Taro in response to the Q (question) mail 703. Furthermore, when A Taro sends Q (question) mail 705 in response to the Ans (answer) mail 704 from B Taro, there is Ans (answer) mail 706 from B Taro in response to the Q (question) mail 705. Moreover, mail 707 from C Taro illustrates an Ans (answer) in response to Q (question) mail 701 that is sent by A Taro. In other words, as illustrated in FIG. 3A, by entering the mail address of C Taro in the destination (CC) of mail 701 that is sent by A Taro, the mail-correlation diagram 700 illustrates that there is an Ans (answer) mail 707 from C Taro in response to the Q (question) mail 701 from A Taro.

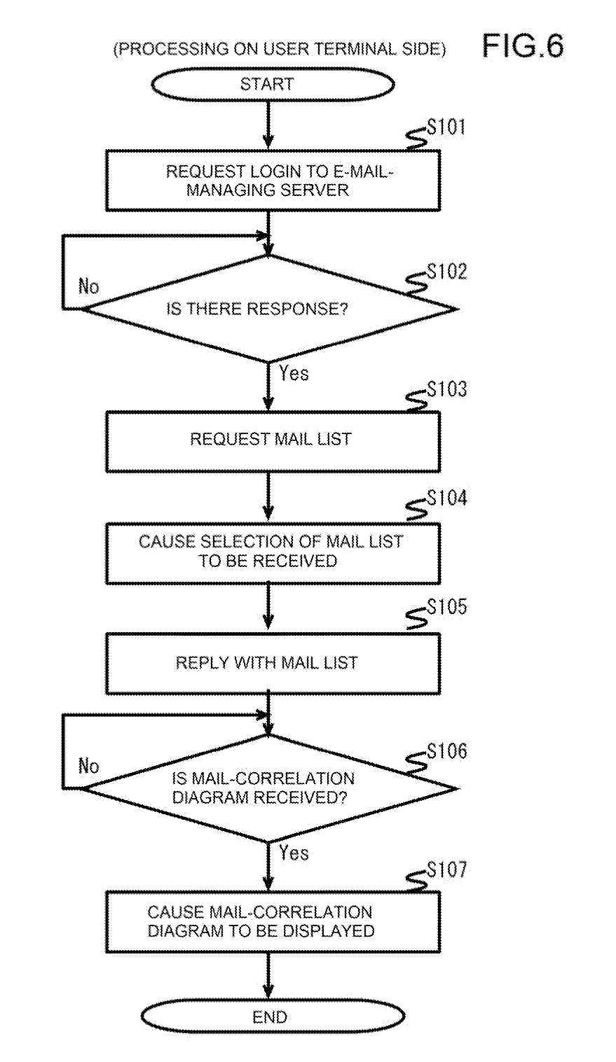

Next, processing on the user terminal 100 side will be explained with reference to FIG. 6. In the following explanation, it is presumed that sent mail and received mail that are stored in the outbox and the inbox are transferred to the e-mail-managing server 200 from the user terminal 100.

### (Step S101)

The system-control unit 118 requests login to the e-mail-managing server 200.

In this case, when login is instructed on the login-request screen that is displayed by the display unit 104, the system-control unit 217 requests login to the e-mail-managing server 200.

### (Step S102)

The system-control unit 118 determines whether or not there is a response.

In this case, the system-control unit 118 determines there is no response when there is no notification from the communication-control unit 113 indicating that a response is received (Step S102: NO).

However, the system-control unit 118 determines there is a response when there is a notification from the communication-control unit 113 indicating that a response is received (Step S102: YES), and processing moves to step S103.

### (Step S103)

The system-control unit 118 requests a mail list 500.

In this case, where there is an acquisition request for the mail list 500 illustrated in FIG. 3B on a mail-list-request screen that is displayed by the display unit 104, the system-control unit 118, via the communication-control unit 113, outputs a send request for a mail list 500 to the e-mail-managing server 200.

### (Step S104)

The system-control unit 118 causes the selection of the mail list 500 to be received.

In this case, the operation-control unit 115, via the mouse 103 for example, receives the selection of the mail-management number (0003) that corresponds to the specified mail (for example, mail 701 in FIG. 5) and the mail-management number (0080) that corresponds to the last mail (for example, mail 706 in FIG. 5) of the mail exchange (for example, mail 701 to 707 in FIG. 5).

### (Step S105)

The system-control unit 118 replies with the mail list 500.

In this case, the operation-control unit 115 receives the selection of the mail-management number (0003) that corresponds to the specified mail (for example, mail 701 in FIG. 5) and the mail-management number (0080) that corresponds to the last mail (for example, mail 706 in FIG. 5) of the mail exchange (for example, mail 701 to 707 in FIG. 5), and further receives the selection of the send button 510. As a result, the system-control unit 118, via the communication-control unit 113, replies with the mail list 500 to e-mail-managing server 200.

### (Step S106)

The system-control unit 118 determines whether or not a mail-correlation diagram 700 has been received.

In this case, when there is no notification from the communication-control unit 113 indicating that the mail-correlation diagram 700 is received, the system-control unit 118 determines that the mail-correlation diagram 700 has not been received (step S106: NO).

However, when there is a notification from the communication-control unit 113 indicating that the mail-correlation diagram 700 is received, the system-control unit 118 determines that the mail-correlation diagram 700 has been received (step S106: YES), and processing moves to step S107.

### (Step S107)

The system-control unit 118 causes the mail-correlation diagram 700 to be displayed.

In this case, the system-control unit 118 instructs the display-control unit 116 to display the mail-correlation diagram 700 that is received from the e-mail-managing server 200.

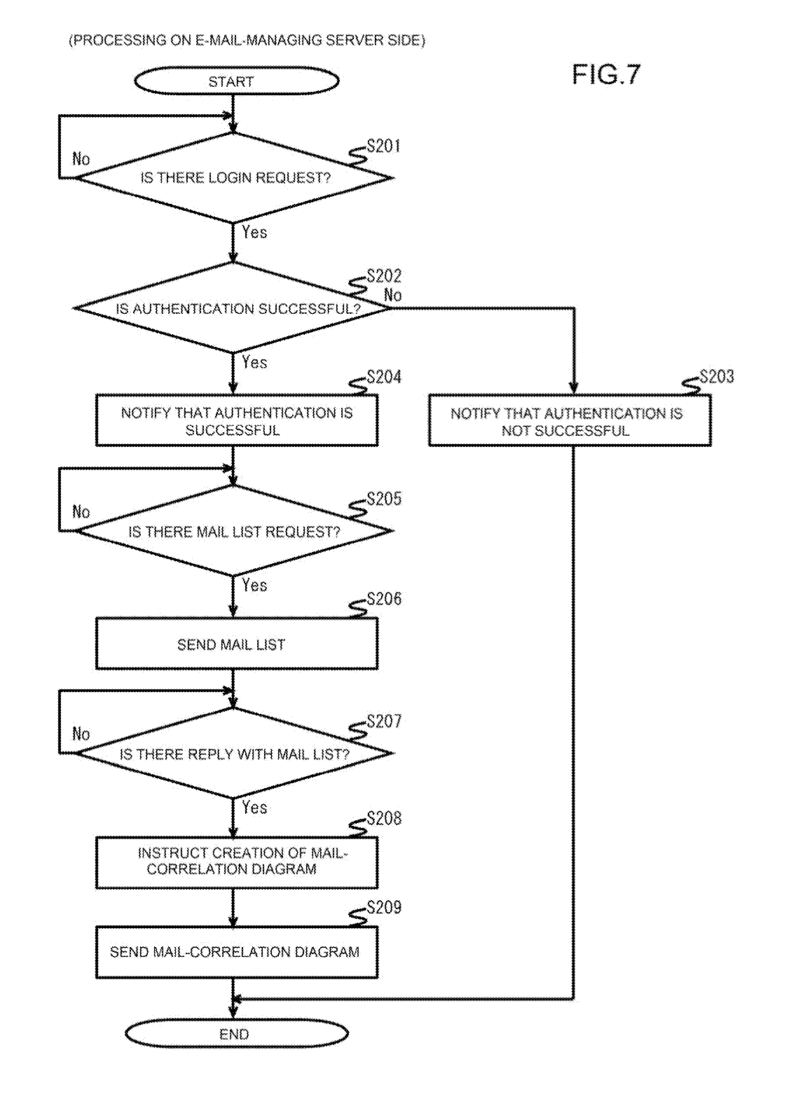

Next, the processing on the e-mail-managing server 200 side will be explained with reference to FIG. 7. In the following explanation, it is presumed that sent mail and received mail that are received from the user terminal 100 and stored in the outbox and the inbox are stored in the HDD 202.

### (Step S201)

The system-control unit 217 determines whether or not there is a login request.

In this case, when there is no notification from the communication-control unit 213 indicating that a login request has been received, the system-control unit 217 determines that a login request has not been received (step S201: NO).

However, when there is a notification from the communication-control unit 213 indicating that a login request has been received, the system-control unit 217 determines that a login request has been received (step S201: YES), and processing moves to step S202.

The system-control unit 217 delivers the user name and password that are included in the login request to the authentication-managing unit 214, and gives an instruction for authentication.

### (Step S202)

The system-control unit 217 determines whether or not authentication is successful.

In this case, when a notification is received from the authentication-managing unit 214 indicating that authentication is not successful, the system-control unit 217 determines that authentication is not successful (step S202: NO), and processing moves to step S203.

However, when a notification is received from the authentication-managing unit 214 indicating that authentication is successful, the system-control unit 217 determines that authentication is successful (step S202: YES), and processing moves to step S204.

### (Step S203)

The system-control unit 217 notifies that authentication is not successful.

In this case, the system-control unit 217, via the communication-control unit 213, notifies the user terminal 100 that authentication is not successful.

### (Step S204)

The system-control unit 217 notifies that authentication is successful.

In this case, the system-control unit 217, via the communication-control unit 213, notifies the user terminal 100 that authentication is successful.

### (Step S205)

The system-control unit 217 determines whether or not there is a request for a mail list 500.

In this case, when there is no notification from the communication-control unit 213 indicating that a request for a mail list 500 has been received, the system-control unit 217 determines that there is no request for a mail list 500 (step S205: NO).

However, when there is a notification from the communication-control unit 213 indicating that a request for a mail list 500 has been received, the system-control unit 217 determines that there is a request for a mail list 500 (step S205: YES), and processing moves to step S206.

### (Step S206)

The system-control unit 217 sends a mail list 500.

In this case, the system-control unit 217 instructs the mail-managing unit 215 to create a mail list 500. Then, the mail-managing unit 215 creates the mail list 500 illustrated in FIG. 3B.

The system-control unit 217, via the communication-control unit 213 sends the mail list 500 that is created by the mail-managing unit 215 to the user terminal 100.

### (Step S207)

The system-control unit 217 determines whether or not there is a reply with a mail list 500.

In this case, when there is no notification from the communication-control unit 213 indicating that a reply with a mail list 500 has been received, the system-control unit 217 determines that there is no reply with a mail list 500 (step S207: NO).

However, when there is a notification from the communication-control unit 213 indicating that a reply with a mail list 500 has been received, the system-control unit 217 determines that there is a reply with a mail list 500 (step S207: YES), and processing moves to step S208.

The system-control unit 217 gives an instruction to create a mail-correlation diagram 700.

In this case, the system-control unit 217 instructs the mail-managing unit 215 to create a mail-correlation diagram 700. Moreover, the system-control unit 217 delivers the mail list 500 that was sent from the user terminal 100 to the mail-managing unit 215.

Then, the mail-managing unit 215 searches the mail-management numbers 601 for mail with a Q (question) tag or an Ans (answer) tag attached between mail 701 that corresponds to mail-management number (0003) and mail 706 that corresponds to mail-management number (0080) that are selected in the mail list 500. Moreover, the mail-management unit 215, after searching the mail-management numbers 601 with a Q (question) tag or an Ans (answer) tag attached, read the corresponding sent mail and received mail from the HDD 202, and creates a mail-correlation diagram 700 that illustrates the contents of the exchange of respective mail 701 to 707 in a timeline.

### (Step S209)

The system-control unit 217 sends the mail-correlation diagram 700.

In this case, the system-control unit 217, via the communication-control unit 213, sends the mail-correlation diagram 700 that is created by the mail-managing unit 215 to the user terminal 100.

In this way, in this embodiment, sent mail and received mail that include tags that specify the category of the contents of the message from a user terminal 100 are stored by the HDD 202 (store device) of the e-mail-managing server 200. Then, the mail-managing unit 215, based on the tags, creates a mail-correlation diagram 700 that indicates the contents of the exchange of mail 702 to 707 for specified mail 701, for example. The system-control unit 217 then sends the mail-correlation diagram 700 that is created by the mail-managing unit 215 to the user terminal 100. As a result, by using the mail-correlation diagram, it is possible to express the correlation of the contents of the exchange of mail 701 to 707, and it is possible to easily perform a check of the contents of the mail exchange for specified mail, for example, mail 701.

Incidentally, in the case of an e-mail display apparatus according to typical technology described above, mail is displayed in threads in line units, so even in the case of mail in which plural subjects are mixed, it is possible to perform a batch display reply comments for each subject. However, in this e-mail-display apparatus, the parent-child relationship of mail is displayed in a hierarchical structure, so when checking the exchange for specified mail, it is necessary to check the contents of messages that are displayed in line units.

In other words, when the parent-child relationship of mail is displayed in a hierarchical structure, reply mail in response to sent mail is displayed on a timeline regardless of the contents of the mail messages. Therefore, in order to check the contents of necessary mail, it becomes necessary to check the contents of messages that are displayed in line units.

More specifically, it is presumed that trouble has occurred in a device, for example. When Mr. A that performs maintenance work finds a comment that is related to the current trouble in an exchange of mail that was received by Mr. A one year ago, Mr. A may want to check the contents of messages that were sent by Mr. B of the party that sent the mail. However, the total number of mail exchanges is enormous, and replies to persons included in CC (Carbon Copy) may also be included. In this case, it is considered that it possible to perform a batch display of only mail that is related to the mail having the comment related to the current trouble, it would be possible to easily check the contents of the mail exchange for the specified mail. Therefore, development of a method that makes it possible to easily check the contents of the exchange for the specified mail is desired.

With the e-mail-managing apparatus and the recording medium according to the present disclosure, by using a mail-correlation diagram, it is possible to express the correlation of the contents of a mail exchange, and thus it is possible to easily perform a check of contents of an exchange for a specified mail.

In this embodiment, a case is explained in which an e-mail-managing server 200 manages sent mail and received mail from a user terminal 100, however, the embodiment is not limited to this example, and the embodiment may also be applied to other mail-delivery servers such as an SMTP server or the like that is managed by a communications business.

What is claimed is:

1. An e-mail managing apparatus, comprising:
a storage device that stores sent mail and received mail including tags for identifying the categories of the contents of messages from a user terminal;
a mail-managing unit that, based on the tags, creates a mail-correlation table that indicates the contents of a mail exchange for a specified mail; and
a system-control unit that sends the mail-correlation table that is created by the mail-managing unit to the user terminal.

2. The e-mail managing apparatus according to claim 1, wherein
the system-control unit, when there is a request for a mail list from the user terminal of the sent mail and received mail that is stored in the storage device, instructs the mail-managing unit to create a mail list that includes mail-management numbers; and
the mail-managing unit manages the sent mail and received mail that are stored by the storage device by the mail-management numbers that are made to correspond with the sent date and time and received date and time of the sent mail and received mail, and sets mail that corresponds to the mail-management number that is selected on the user-terminal side as the specified mail.

3. The e-mail managing apparatus according to claim 1, wherein
the mail-managing unit:
regards the mail-management numbers as being arranged in ascending order of sent date and time and received date and time; and
when two mail-management numbers are selected on the user terminal side, regards the mail corresponding to the smaller mail-management number as being the specified mail, and mail corresponding to the larger mail-management number as being the last mail of a mail exchange.

4. The e-mail managing apparatus according to claim 1, wherein
the mail-managing unit:
regards the mail-management numbers as being arranged in descending order of sent date and time and received date and time; and
when two mail-management numbers are selected on the user terminal side, regards the mail corresponding to the larger mail-management number as being the specified mail, and mail corresponding to the smaller mail-management number as being the last mail of a mail exchange.

5. The e-mail managing apparatus according to claim 1, wherein
the mail-correlation diagram indicates the contents of a mail exchange for the specified mail in a timeline.

6. The e-mail managing apparatus according to claim 1, wherein
tags that indicate correspondence are included in the tags.

7. A non-transitory computer readable recording medium that stores an e-mail-managing program that can be executed by a computer of an e-mail managing apparatus, wherein the e-mail-managing program
causes the computer to store sent mail and received mail including tags for identifying the categories of the contents of messages from a user terminal; and
causes the computer to operate as:
a mail-managing unit that, based on the tags, creates a mail-correlation table that indicates the contents of a mail exchange for a specified mail; and
a system-control unit that sends the mail-correlation table that is created by the mail-managing unit to the user terminal.
